(19) United States
(12) Patent Application Publication
(10) Pub. No.: US 2011/0219639 A1
(43) Pub. Date: Sep. 15, 2011

(54) METHOD FOR ESTIMATING THE HEALTH RISK OF A TEST SUBJECT

(76) Inventor: Franz Groisböck, Lower Austria (AT)

(21) Appl. No.: 12/998,570

(22) PCT Filed: Nov. 5, 2009
(86) PCT No.: PCT/AT2009/000424

§ 371 Date: Jun. 1, 2011

(30) Foreign Application Priority Data
Nov. 5, 2008 (AT) A 1723/2008

(51) Int. Cl. F26B 5/00

(52) U.S. Cl. 34/443; 34/218

(57) ABSTRACT

A method for drying a material to be dried is described, which is acted upon inside a drying chamber by a drying gas guided in a circuit and heated by means of a heat exchanger (8) to remove the evaporated liquid. In order that a low external energy input is sufficient, it is proposed that a part of the drying gas stream is separated from the circuit, compressed and condensed in the heat exchanger (8) whilst releasing heat to the drying gas stream guided in the circuit.

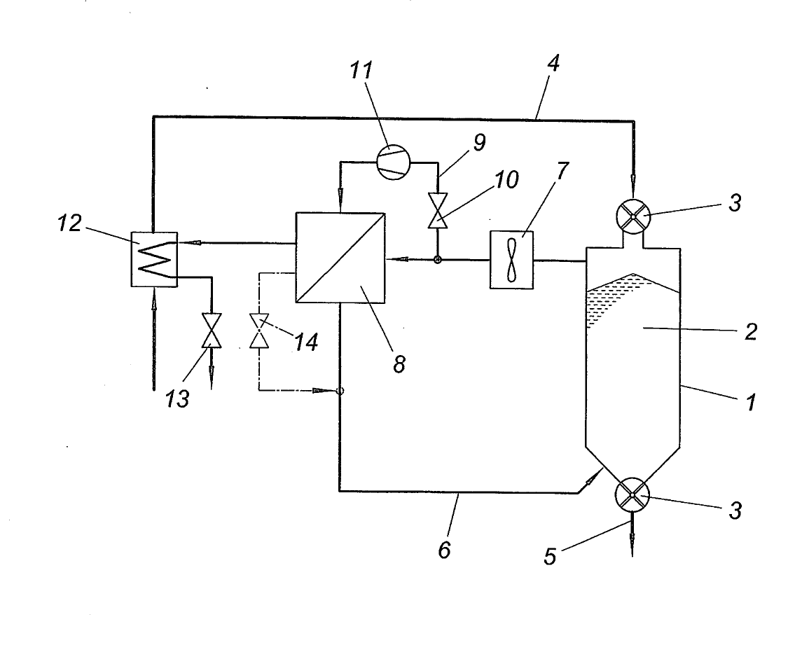

### FIELD OF THE INVENTION

The invention relates to a method for drying a material to be dried which is acted upon inside a drying chamber by a drying gas guided in a circuit and heated by means of a heat exchanger to remove the evaporated liquid.

### DESCRIPTION OF THE PRIOR ART

For drying moist solids it is usual to act upon the material to be dried with a preferably preheated drying air stream and remove the moisture to be evaporated from the material to be dried with the drying air stream. In order to be able to advantageously dry fine-grained material, it has already been proposed to guide the drying gas stream, air or an inert gas, for example, nitrogen, in the circuit via drying containers (US 3 599 344 A) through which the material to be dried is conveyed continuously via locks on the inlet and outlet side in the opposite direction to the drying gas stream. To accelerate the drying process the material to be dried is heated with the aid of heat exchangers inside the drying containers, for example, with hot steam. The steam-laden drying gas removed from the drying containers by means of cyclone separators is conditioned with regard to the moisture content, the temperature and the pressure in order to be able to maintain predefined drying conditions inside the drying containers. A disadvantage however is the constructive expenditure and the circumstance that considerable quantities of external energy must be used for the drying.

Similar disadvantages are obtained in another known method (GB 1 201 354 A1) in which a drying gas stream comprising an inert gas is passed in the circuit through a two-stage drying container to evaporate solvents from a granular material. A corresponding uniform evaporation of the solvent from the material to be dried conveyed continuously through the drying chamber should be ensured through a complex guidance of the heated drying gas stream inside the drying container. The solvent vapour removed with the drying gas stream from the drying chamber is condensed and separated in a condenser whilst the cooled drying gas stream must be reheated in a downstream heat exchanger.

Finally, for using the sensible waste heat of the vapour accumulating during the drying of brown coal, it is known (EP 0 268 819 A2) to compress the vapour for better utilisation of heat and to heat heating steam with the compressed vapour in the heat exchanger in order to preheat the brown coal to the vaporisation temperature with the heated heating steam in the heat exchanger inside a multistage drying container. In the subsequent drying stages, the material to be dried is heated using fresh vapour which in turn acts upon corresponding heat exchangers. In this case, the energy input is also appreciable if a steam source cannot be accessed.

### SUMMARY OF THE INVENTION

It is therefore the object of the invention to configure a method for drying a material to be dried of the type described initially such that a comparatively low expenditure of external energy can be sufficient.

The invention achieves the formulated object by separating a part of the drying gas stream from the circuit, compressing it and condensing it in the heat exchanger whilst releasing heat to the drying gas stream guided in the circuit.

As a result of this measure, the drying gas stream guided in the circuit is not guided via a condenser for separating the vapour received from the material to be dried so that the main component of the drying gas stream consists of water vapour which has been absorbed from the material to be dried. Only a partial stream is branched off from this drying gas stream guided in the circuit in order to heat the drying gas stream guided in the circuit with the aid of this branched-off partial stream following a corresponding compression and associated increase in temperature so that as a result of the increased temperature of the drying gas stream supplied to the material to be dried, vapour can be additionally absorbed from the material to be dried and specifically as far as saturation of the drying gas stream cooled as a result of the release of heat to the material to be dried. The operating parameters can be matched to one another so that the volume of the water vapour newly absorbed by the drying gas stream from the material to be dried substantially corresponds to the volume of the partial stream of the drying gas branched off from the drying circuit so that substantially constant flow conditions are established in the circuit flow of the drying gas. Since the dew point for this partial stream increases with the compression of the partial stream branched off from the circuit, due to the release of heat to the drying gas stream guided in the circuit the dew point is fallen below, the vapour contained in the partial stream condenses and the condensate is separated. This means that water vapour is continuously separated from the drying gas stream guided in the circuit and can be fed continuously to the drying process and specifically with a comparatively low input of external energy because merely the partial stream branched off from the circuit of the drying gas stream must be compressed accordingly. The economic viability of this drying process thereby increases with the water vapour content of the drying gas stream.

The drying method according to the invention is particularly suitable for the continuous drying of bulk material that is conveyed continuously via suitable locks through the drying chamber. However, a batchwise drying of the material to be dried is also possible, for example, in connection with the drying of sawn timber if, for the batchwise drying of the material to be dried, the drying gas stream is guided alternately via at least two drying chambers in the circuit which serve to receive respectively one batch of material to be dried.

In order to increase the drying performance, the partial stream branched off from the circuit of the drying gas can be increased, whereby the gaseous fraction of the partial stream of the drying gas condensed in the heat exchanger is supplied to the drying gas circuit again so that again constant flow conditions can be established in the area of the drying chamber.

An apparatus comprising at least one drying container to receive the material to be dried, comprising a circulating system for a drying gas acting upon the drying container and comprising a heat exchanger for heating the drying gas stream guided in the circuit can be taken as the starting point for carrying out the method. The heat exchanger for heating the drying gas stream guided in the circuit does not follow a condenser for separating the condensed water vapour from the drying gas circuit, as in conventional drying apparatuses, but is connected to a compressor for a partial stream of the drying gas branched off from the circulating system so that as a result of the higher temperature of the compressed partial stream, the drying gas stream inside the circulating system can be heated. With the release of heat of the compressed partial stream to the circuit flow of the drying gas stream, the temperature of the compressed partial stream decreases below the dew point increased as a result of the compression so that the water vapour contained in the partial stream can be condensed and removed.

The residual heat of the condensate and the remaining gas component of the partial stream can be used for heating the material to be dried. For this purpose the material to be dried can be acted upon with the waste heat of the partial stream outside the drying container in a separate heat exchanger.

Particularly advantageous structural relationships are obtained if the heat exchanger for heating the drying gas stream guided in the circuit is located in the drying container itself so that the waste heat of the partial stream can be transmitted via the housing wall of this heat exchanger directly to the material to be dried substantially by heat conduction.

### BRIEF DESCRIPTION OF THE DRAWING

The method according to the invention is explained in detail with reference to the drawing and specifically this shows an apparatus for drying a material to be dried according to the invention in a schematic block diagram.

### DESCRIPTION OF THE PREFERRED EMBODIMENT

The apparatus shown for drying a material to be dried comprises a drying container 1 for the material to be dried which is conveyed continuously through the drying container 1 in the form of bulk material 2 via locks 3 on the inlet and outlet side, in the present case rotary valves. The inlet line for the material to be dried is designated by 4. The dried material is removed from the drying container 1 via an outlet line 5.

For drying the bulk material 2, the drying chamber of the drying container 1 is acted upon by a drying gas. For this purpose the drying container 1 is connected to a circulating system 6 for a drying gas stream which comprises a fan 7 for circulating conveyance of the drying gas and a heat exchanger 8 for heating the drying gas stream removed from the drying container 2. This heat exchanger 8 is acted upon by a partial stream of the drying gas which is removed via a branch line 9 of the circulating system 6 via a metering valve 10 and is brought to a higher pressure by means of a compressor 11 in order to be able to heat the drying gas guided in the circuit with the aid of the associated temperature increase. Since with compression of the partial stream of the drying gas, the dew point thereof increases, the water vapour contained in the partial stream can be condensed at a temperature above the input temperature of the drying gas stream guided in the circuit. The condensate can be supplied with the remaining gaseous component of the branched-off partial stream to a heat exchanger 12 for preheating the material to be dried. The pressure valve 13 used for the pressure build-up inside the heat exchanger 8 can in this case preferably be located downstream of the heat exchanger 12 for preheating the material to be dried in order to be able to use the higher temperature level of the partial stream from the heat exchanger 8, which has not yet expanded.

The drying gas guided in the circuit and heated in the heat exchanger 8 flows through the bulk material 2 to be dried in the drying container 1, whereby whilst simultaneously releasing heat to the material to be dried, water vapour is absorbed from the material to be dried until saturation is achieved. As a result of the branching off of a partial stream of the drying gas withdrawn from the drying container 1, for example, to the extent of the vapour volume absorbed from the bulk material 2, and the subsequent heating of the drying gas 6 guided in the circuit via the heat exchanger 8, the drying gas stream supplied to the drying container 1 can be adjusted so that taking into account the cooling inside the drying container 1, it again absorbs the amount of vapour corresponding to the branched-off partial stream so that continuous flow conditions for the drying gas can be observed in the area of the drying container 1.

In order that an increased drying rate can be ensured, the amount of vapour to be absorbed via the drying gas stream should be increased which necessitates a larger partial stream of the drying gas via the compressor 11. So that uniform flow conditions in the drying container 1 can again be achieved under these conditions, the gaseous component of the branched-off partial stream remaining after condensation of the vapour can be removed from the heat exchanger 8 and fed back to the circulating system 6 via an expansion valve 14.

1. A method for drying a material to be dried which is acted upon inside a drying chamber by a drying gas guided in a circuit and heated by means of a heat exchanger (8) to remove the evaporated liquid, wherein a part of the drying gas stream is separated from the circuit, compressed and condensed in the heat exchanger (8) whilst releasing heat to the drying gas stream guided in the circuit.

2. The method according to claim 1, wherein the material to be dried is conveyed continuously through the drying chamber via locks (3).

3. The method according to claim 1, wherein for batchwise drying of the material to be dried, the drying gas stream is guided alternately via at least two drying chambers in the circuit to receive respectively one batch of material to be dried.

4. The method according to claim 1, wherein the material to be dried is preheated with the aid of the sensible waste heat of the partial stream of drying gas condensed in the heat exchanger (8).

5. The method according to claim 1, wherein the gaseous fraction of the partial stream of drying gas condensed in the heat exchanger (8) is fed back to the circuit of the drying gas.

6. An apparatus for drying a material to be dried comprising at least one drying container (1) to receive the material to be dried, comprising a circulating system for a drying gas acting upon the drying container (1) and comprising a heat exchanger (8) for heating the drying gas stream guided in the circuit, wherein the heat exchanger (8) for heating the drying gas stream guided in the circuit is connected to a compressor (11) for a partial stream of the drying gas branched off from the circulating system (6).

7. The apparatus according to claim 6, wherein the heat exchanger (8) for heating the drying gas stream guided in the circuit is located in the drying container (1).
